(19) United States
(12) Patent Application Publication
(10) Pub. No.: US 2004/0119375 A1
(43) Pub. Date: Jun. 24, 2004

(54) Cosmic flux driven electrostatic turbine

(76) Inventors: Robert Johan Ney, Albuquerque, NM (US); John P. Brainard, Albuquerque, NM (US); Robert Douglas Ney, Albuquerque, NM (US)

Correspondence Address: Robert J. NEY, 1304 Narcisco St NE., Albuquerque, NM, 87112-6615, US

(21) Appl. No.: 10/328,383

(22) Filed: Dec. 24, 2002

(51) Int. Cl. H02N 1/00

(52) U.S. Cl. 310/309

(57) ABSTRACT

One hundred thousand years ago a Caveman observed that a thrown stone always fell to the ground, and postulated that the ground mysteriously attracted the stone. One hundred thousand years later, and 315 years after Sir Isaac Newton published his Gravitational Force Equation, most People and Physicists still believe in this myth.

It is well known that charged capacitor plates exhibit significant “attractive” forces between the plates, this invention is just converting this available short linear motion to a continuous circular motion. The Energy for the resulting motion is derived completely from the Cosmic Flux Field; the Electrostatic charge of the Rotor/Stator is not depleted!

The Ney-Brainard-Ney “Cosmic Flux Field Theory”, and an Algorithm for calculating CF Turbine Rotor Torque is presented; they explain most of the mechanism of the “Invisible Forces at a Distance” (Gravitational, Electrostatic, and Magnetic). The Newton/Coulomb form of “Attraction” Force Equations are a great oversimplification of the Fundamental Physical Phenomena; it generally disregards the specific Attenuation/Impact Force of the Cosmic Flux traversing matter, which is the basis of all Cosmic Flux Forces! The N/C Equation “blows up” to infinity when Centroids overlap and “d²” in the denominator is zero. The Cosmic Flux Attenuation/Impact Forces of the Cosmic Flux paths traversing the Stators and Rotor must be Vectorially integrated, this will result in a net torque on the Rotor. In cases of relatively small Spherical mass diameters, at Astronomical distances apart, in Vacuum, of course Newton's approximation is quite accurate. The subject Cosmic Flux Electrostatic Turbine is rejected off hand by “conventional wisdom”, because each element of the Stator is perfectly symmetrical to the Rotor axis “hence no net Force/Torque can exist on the Rotor”. This conventional wisdom completely disregards the Fundamental Physical Phenomena.

### BACKGROUND OF THE INVENTION

René Descartes (1596-1650) emphatically believed that: “the Cosmos is filled with a fluid more dense than matter, yet invisible, and it is in continuous motion (Flux) [Theory of Cosmological (Flux) Impact]. Descartes rejected Galileo's Pendulum and Free Fall experimental conclusions, because Galileo “failed to reduce the mathematical laws of moving bodies to their ultimate mechanism”.

Sir Isaac Newton (1642-1727) published the “Principia” in 1687, stating the three Laws of Motion, the Law of Gravitation, and confirmed by Pendulum experiments the Law of equivalence of Gravitational and Inertial Forces. Newton deduced his Gravitational Force Equation from observations of the orbit of the Moon around the Earth (nothing was said about the “Apple”). There is no indication that Newton proposed to use this equation for other than Astronomical purposes, with “large” Mass Spacing to Mass Diameter ratios. It is highly questionable that Newton would have agreed with the Cavendish Measurement of the Universal Gravitational Constant “G” (over a hundred years after the publication of “Principia”), at “small” Mass Spacing to Mass Diameter ratios. At Astronomical Spacing “S” to Star or Planet Diameter “D” ratios, the mutually corresponding Cosmic Flux Rays are nearly parallel, while at close spacing, the parallel Rays remain identical however significant amount of mutually corresponding angular Rays are introduced! One would expect a higher Universal Gravitational Constant “G” measurement at the later case. Observations of “Proximity Anomalies of Newtonian Gravitation” has been indicated in the Literature.

Newton was ridiculed for some of his Laws of Physics by his contemporaries, particularly on the European Continent.

George Le Sage (1724-1803) his paper on the “Pushing theory of Gravitation” by “particules ultramundanes (out of this World particles) raining down on us”; attempting to explain the mechanics of Newtonian Gravitation. Before Conrad Rontgen discovered X-rays in 1896, it was not known that invisible particles can traverse matter. Le Sage also suggested that the structure of matter is also held together by this “out of this World fluid”. Gravity is an extremely weak force compared to Electrostatic or Magnetic forces, which are about 20 orders of magnitude larger for the same volumes. Gravity appears strong because we are sitting on the huge mass of the Earth. In free space, in orbit, or in the Horizontal Plane on Earth, we have “Micro-Gravity”. Descartes' and Le Sage's “Theory of Cosmological (Flux) Impact” was generally ignored or ridiculed over the Centuries; and it is rarely known in our times, even by the Scientific Community.

Charles Coulomb (1736-1806) with his Torsional Balance in 1784 determined that the force between 2 Electrostatically charged Spheres varies as the inverse square of the spacing between the Centroids. This resulted in an Electrostatic Force Equation similar in form to Newton's Equation for Gravitation. Ever since 1784 some scientists theorized that all “invisible forces at a distance” are closely related. Coulomb also measured the Cosmological Constant for Electrostatics.

Sir Henry Cavendish (1731-1810) in 1798 using a modified Coulomb Torsional Balance, using two Spherical metal masses, at relatively close Spacing, measured the value of the Universal Gravitational Constant “G”, the value of which Newton never knew. Close spacing of the Spheres were necessary since the equipment was so insensitive, in the Earth's Horizontal Micro Gravity Field.

The Universal Gravitational Constant “G” measured by Cavendish, is a Constant of the Cosmic Flux Field; its Units are: Force Area/Mass² or Force Area/Flux Impedance².

Albert Michelson (1852-1931) attempted to prove the existence of the long theorized “Stationary Luminoferrous Ether Field” (light carrying fluid) filling the Cosmos, by using his Optical Interferometer to measure the speed of light, parallel and perpendicular to the Earth's orbital velocity around the Sun (˜30 Km/sec.). James C. Maxwell (1831-1879) was one of the proponents of the now famous Michelson-Morley Experiments. The results were published in 1887, indicating that the hypothetical “Ether Field” had no effect on the speed of Light propagation. These experiments did not prove by any means, that some other type of Cosmic Field does not exists. A number of eminent scientists believed in the existence of some type of Cosmic Force Field, among them: A. A. Michelson, G. G. Stokes, J. H. Poincare, J. Larmour, A. J. Fresnel, G. F. FitzGerald, Lord Kelvin, Lord Raleigh, and J, MacCulagh.

Nikola Tesla (1856-1943) The great Electrical Genius, inventor of the Alternating Current Machinery, designer of the first Niagara Falls Power Plant. Tesla worked on converting “Radiation Energy” into Electric Current, on and off most of his professional life. Tesla received a US Patent on converting X-Ray radiation to Electricity in 1901. Tesla reported near success on converting Cosmic Radiation to Electric Current, in the mid 1930's. When he died in 1943 his “device” was not found.

Albert Einstein (1879-1955) published his work on Photo Electricity in 1905; and the named the “Photon”. Einstein published his work on the “General Theory of Relativity” in 1915. Sir Arthur Eddington at a Solar Eclipse in 1919, verified by measurements Einstein's prediction of the deflection of a “grazing” Light Beam, by the Sun's Gravitational Force, of 1.75 seconds of arc using his Relativistic Equations. This value was confirmed many times with modern instruments. Ballistic trajectory calculations at the speed of light, using conventional Newtonian Gravitation, the deflection calculates to be ˜0.86 seconds of arc, or about half of the correct value. Einstein attempted to write a “Unified Field Equation” for Gravitational, Electrostatic, and Magnetic Forces, for the rest of his life, without success. Einstein developed a Correction Factor for Newton's Gravitational Force Equation. M. Nieto of LANL and J. D. Anderson of JPL have been using Einstein's Correction Factor for Earth Satellite Orbit calculations, for existing Satellites for about 2 decades. There was still a slight deviation in the measured Orbit to the calculated Orbit.

Neutrinos. The possible existence of Neutrinos was disclosed in 1930 by Wolfgang Pauli. His disclosure was based on the energy measurements of Beta emission by Ellis and Wooster in 1927. Not until 1956 was the Neutrino actually observed in an experiment by Cowan and Raines, at the Savannah River Laboratory. Cerenkow detector chambers detected three types of Neutrino tracks, named: Beta, Tau, and Muon. Very “large” detector chambers filled with Heavy Water were constructed in the last decades of the 1900's, such as the Super Kamiokonde.

Black Holes. Light absorbing voids in Space were first observed in the Cosmos in the 1950's. The latest thinking is that Black Holes have a solid Neutron Star at their Cores, and the Gravitational force is so great that Photons (light) can not escape its vicinity. We believe that even the Cosmic Flux can not traverse Black Holes, so that the Cosmic Flux flow is uni-directional toward the Black Hole. This will tend to sweep the Photon Flux toward the Neutron Star. This Neutron Star Core is probably among the highest temperature objects in the Cosmos, but its Photons never get out.

Big Bang. “Our Big Bang” occurred about 14.5 Billion years ago. We believe that “myriads” of Big Bangs older than ours and Supernovae in the yet Undetected Cosmos, are the principal sources of the Cosmic Flux. The large number is necessary for the great uniformity of this Flux, as indicated by the uniformity of the “G” measurements (˜0.3%, including measurement errors) in all directions.

A huge Gravitational Observatory (LIGO) is now being constructed, to detect a single Gravity Wave Pressure.

Supernovae and Novae, or Exploding Stars have been recorded from 1054 AD on. Supernovae are characterized by immense output of Photons, Radio Waves, Gamma rays, and most likely Cosmic Flux. There are now over 140 known Supernovae and remnants in the detectable Cosmos. S. Woosley of the University of California reported that bursts of Gamma rays were observed on Apr. 25, 1998, emitted from a Supernova; according to Woosley such bursts occur daily in the observable Cosmos. Recently two Supernovae were observed at the edge of the detectable Cosmos, “hurling away from each other” indicating Gravitational Repulsion.

We believe that our Cosmic Flux Model explains the three Cosmological Enigmas of our times:

1. Mond has recently shown that the missing matter issue goes away if the force described by Newton is slightly reduced at large distances. Our Model predicts such reduction due to attenuation by intervening Mass.

2. The repulsion of Supernovae, that has been recently observed can be easily understood with our Model. With this understanding it becomes obvious that Supernovae would repel each other. At the peak Supernovae light intensity is about 100 million times that of our Sun.

3. The Attenuation of Cosmic Flux traversing matter (shading) would create Spirals from Galaxies that do not have a uniform distribution of mass. Our Model explains this phenomenon and it is exactly why we believe that our Turbine Wheel will rotate driven by the same unbalanced Cosmic Flux Field caused by the particular non-uniform distribution of Mass or Electrostatic Charge.

### (h) BRIEF SUMMARY

This invention attempts to harness some of the abundant Free and clean Energy of the Cosmic Flux Field (see FIG. 1). It is well known that significant forces can exist between charged Capacitor Plates. Mechanical Energy can be extracted from the Cosmic Flux Field by these Plates, as we let them move toward each other over the Capacitor Plate spacing distance “d” (see FIG. 2.). This invention attempts only to obtain continuous rotary motion, instead of the above short linear motion, from an Electrostatically charged Rotor surrounded by charged Stators. Electrostatic Forces are about 20 orders of magnitude larger than Gravitational Forces, for equal volumes.

In order to understand the operation of the subject Cosmic Flux Driven Electrostatic Turbine, one must understand some of the properties of the Cosmic Flux Field that we live in:

A relatively uniform Cosmic Flux traverses all Space and Matter in the Universe (except Black Holes). Most of the Cosmic Flux is generated in the so far Undetectable Cosmos, apparently from myriads of sources. Some of this Flux is also generated by Supernovae in our “Universe”. This Flux converges to and then diverges from every “point” in the Detectable Cosmos (Universe). Schematic Diagrams of the Cosmic Flux Field is presented (see FIGS. 1, 8, and 11). The attenuation of this Flux traversing in a particular Media causes Gravitational, Electrostatic, and Magnetic Forces. In Free Space this Flux is nearly perfectly balanced in all directions, hence no net force is produced on a single mass. Introducing a second mass will result in projecting Attenuated Flux on each other, resulting in Gravitational Thrust by the inline Un-Attenuated Flux (commonly called: “Attraction”). In the Gravitational Media the proverbial thrown “Stone” has no mechanical energy of its own, other than its initial imparted Momentum, it is just being carried by a net Cosmic Flux Vector, toward the Earth.

The Cosmic Flux Particles behave much like Gas Molecules, they “bounce around” in all directions in a vessel, except Cosmic Flux Particles are one of the smallest Particles known (Neutrino Cross Section: ˜10⁻44 cm²), hence their Free Mean Path in Vacuum may be measured in Light Years. They must also be highly energetic. Even in most solids the Mean Free Path is “very” long, as indicated by Planets orbiting Stars; if the Cosmic Flux could not penetrate the Star, this would be a Black Hole region, and the Planet would fall into the Star (and we would never see the Star).

Significant Forces are developed due to the “extremely” large number of particles traversing every cm³/sec. in the Detectable Cosmos. (The speed of these Particles may be larger than that of Light; in Einstein's time not much was known about Neutrinos).

Photons in a well lighted “white” walled room behave somewhat similar to the Cosmic Flux Particles, they are crisscrossing the room in every direction, with no apparent interactions, and there is no absence of Light anywhere. Of course Light does not penetrate the wall material since Photons are too large in Cross Section, (Thompson's Collision Differential Cross Section is in the range of 10⁻²⁷ cm²), and Light Photons are relatively low Energy Particles.

The Newton/Coulomb “Attraction” Force Equation only applies exactly for point Masses or Charges separated by Vacuum! Any other application is an approximation and an artifact! If one works with Finite or Differential Elements within a Configuration, the intervening Flux Impedances to and between these Masses or Charges must be considered!!! See FIG. 4 & FIG. 5). This is the Nature of the Phenomena of Attenuation/Impact produced invisible Forces at a distance, caused by the Cosmic Flux traversing an Impeding Media!!!

Newton's Gravitational Force Equation lumps the total Body Impedance (Mass) to the Centroid of the Body Configuration, and completely disregards the multitude of specific Flux Paths and specific Impedances of the Body Configuration.

Both Coulomb and Cavendish used Spheres in their Torsional balances, to measure the Universal Constants (G & k) in the Newton/Coulomb Force Equations. Spheres are the only shapes where the Cosmic Flux correspondence between the two Bodies are not a function of alignment; the Cosmic Flux Impedances of Spheres are constant in all directions.

Of course the Charges must have been distributed on the surface of Coulomb's Spheres. The Electrostatic Charge Intensity at Centroid approximation for Cosmic Flux Impedances are not applicable to complex configurations such as the Cosmic Flux Driven Electrostatic Turbine, as indicated above. Moreover, if the Electrostatic “attraction” were calculated between Stators and Rotor in the subject Turbine, since the Centroids are overlapping the “d” spacing is zero in the denominator, hence the Equation “blows up”.

A new concept had to be developed to optimize the Turbine designs. It is theorized that the path length of the Cosmic Flux Rays traversing a homogeneous Impedance configuration is proportional to the Force imparted to the impeding Media, and the Force is in the direction of the Flux Rays. This principle holds in all domains!!!.

Finite Element Vector Integration was performed on the Rotor circumference in a Plane perpendicular to the axis of rotation. A 10° Solid Angle “Flux bundle” Models were used for illustration. The Flux Vector input points were at 8×45° intervals on the circumference of the Rotor, at 36×10° Flux Vector inputs at each point. Sample Vector Diagrams (see FIGS. 4 & 5), and Tabulated Results are presented for one 10° and one 20° Zero Impedance Solid Angle Input Slot. Supercomputers can be used to calculate and integrate the elemental rotational component forces on every finite element in the Rotor from all directions (360° azimuth, and 360° elevation), using finite solid angle Flux bundles passing through the Stators. Force/Unit Length of Solid Angle Flux Traversed should be determined Empirically for given voltages.

Maximum Power Output is reached, at least theoretically, when the Stator and Rotor Impedances are so great the Cosmic Flux can not penetrate them (See FIG. 3).

The above Finite Element Vector Analysis can be used to compare various Electrostatic Cosmic Flux Turbine designs, even before the “Solid Angle Force/Unit Length Traversed in the Media” Constant is determined for a particular Turbine.

The Ney-Brainard-Ney Cosmic Flux Field Theory is stated. Attempts are being made to experimentally substantiate some of the points of the N-B-N Cosmic Flux Field Theory, using a baseline Electrostatic CF Turbine working model.

Schematic Diagrams of the proposed Electrostatic CF-Turbine is presented.

A Schematic Diagram of the proposed “Fabric of Space” is presented; the Particle Cross Section of 10⁴⁴ cm² assumes that the Particle is a Neutrino

### DESCRIPTION OF DRAWINGS

FIG. 1. A Schematic Diagram of the Cosmic Flux Particle Paths in a 60° grid, in 2 Dimensions. The actual grid is in 4 Dimensions (X,Y,Z, and Time).

FIG. 2. A Schematic Diagram of a cross section of a pair of charged Capacitor Plates;

one Plate is fixed, the other Plate is accelerating toward the fixed Plate, driven by Electrostatic Forces “F”, and moving over spacing “d”. 1” is the resultant Cosmic Flux Vector perpendicular to the Capacitor Plates. (Work=Force×distance).

FIG. 3. A Schematic Diagram of a Theoretical Ultimate Cosmic Flux Turbine for simple illustration of the principle of operation: a Cosmic Flux Impervious (100% Flux Impedance) Rotor and Stator, with the Stator surrounding the Rotor; the Stator having one open slot generally tangent to directed toward the periphery region of the Rotor. This principle should work at a lower Rotor/Stator Impedance level, at a lower Power Output.

FIG. 4. A sample of the Finite Element Graphical Vector Analysis of the Cosmic Flux Impedance Vectors tangent to the Rotor circumference, using 36×10° solid angle Flux Elements at each point, at 8×45° apart on the circumference of the Rotor, shown at the 0° location.

FIG. 5. Same as FIG. 4. shown at the 270° location.

FIG. 6. Is an Isometric broken out Elevational Sectional View of the proposed Cosmic Flux Electrostatic Turbine. Part of the Electric Generator Chamber and the Turbine Output Shaft is shown.

FIG. 7. Is a broken out Top View of the Cosmic Flux Electrostatic Turbine with the Rotor and Stator Assembly, with 4 open Slots directed toward the Periphery region of the Rotor, with the Chamber sealing flange shown.

FIG. 8. Is a Schematic Diagram Illustrating the inverse square attenuation in Vacuum concept of the Newton/Coulomb Force Equation.

FIG. 9 Is a Schematic Diagram of the Corresponding Cosmic Flux Lines traversing 2 Spheres in close proximity, shown in 2 dimensions; indicating both Parallel and Angular Corresponding Flux Lines.

FIG. 10. Is a Schematic Diagram of the Corresponding Cosmic Flux Lines traversing 2 Spheres at Spacing “S”; where the Sphere diameters “D” are orders of magnitude smaller than the Spacing “S”. It is shown in 2 dimensions; indicating only Parallel Corresponding Flux Lines. Angular Corresponding Flux lines do not exist.

FIG. 11. Is a Schematic Diagram of the Fabric of Space. The Cosmic Particle size assumed corresponds to the Neutrino Cross Section of about 10⁻⁴⁴ cm².

### DETAILED DESCRIPTION

Newton's Equation of Gravitational Force is a great oversimplification of the Fundamental Physical Phenomena of mass “attraction” ! Lumped Impedance parameters (Total Mass at Centers of Gravity) are used for the Cosmic Flux Impedance, and the mass spacing “d” is measured between the artifact CG's, while the media Impedance between the masses (vacuum) is assumed to be zero. This works fine for relatively small spherical mass Diameters at great Spacings “d” apart, in Vacuum (Astronomy).

For the Cosmic Flux (Driven) Electrostatic Turbine the Newton/Coulomb form of “attraction” Force Equation is not applicable! In this Turbine the Centroids of the Rotor and Stators overlap, resulting in a “d²” of zero in the denominator and the Equation “blows up” to infinity. The intervening material of the Rotor and Stator has a significant Impedance to the Cosmic Flux traverse, which is the basis of all Gravitational and Electrostatic Forces in the first place.

A novel Algorithm for comparing various designs for Torque Output/Volume was developed. The Cosmic Flux Turbine (CFT) is based on 4 Principles of the Ney Brainard Ney (NBN) Cosmic Flux Field Theory:

A. The hypothetical Cosmic Flux Energy*, which fills the Greater Universe: *Cosmic Flux traversing a specific media results in Gravitational, Magnetic, and Electric Forces; Gravitational Forces are about 20 orders of magnitude smaller than the Magnetic or Electric Forces for comparable volumes. The Converging Diverging (at all points) Flux Field with inverse square dispersion with distance, and the substantially linear attenuation with traversing an Impedance (mass, or charged body) is considered. The attenuation of the Cosmic Flux traversing matter, however, it is actually non-linear in the second order (see U.S. Pat. No. 6,353,311).

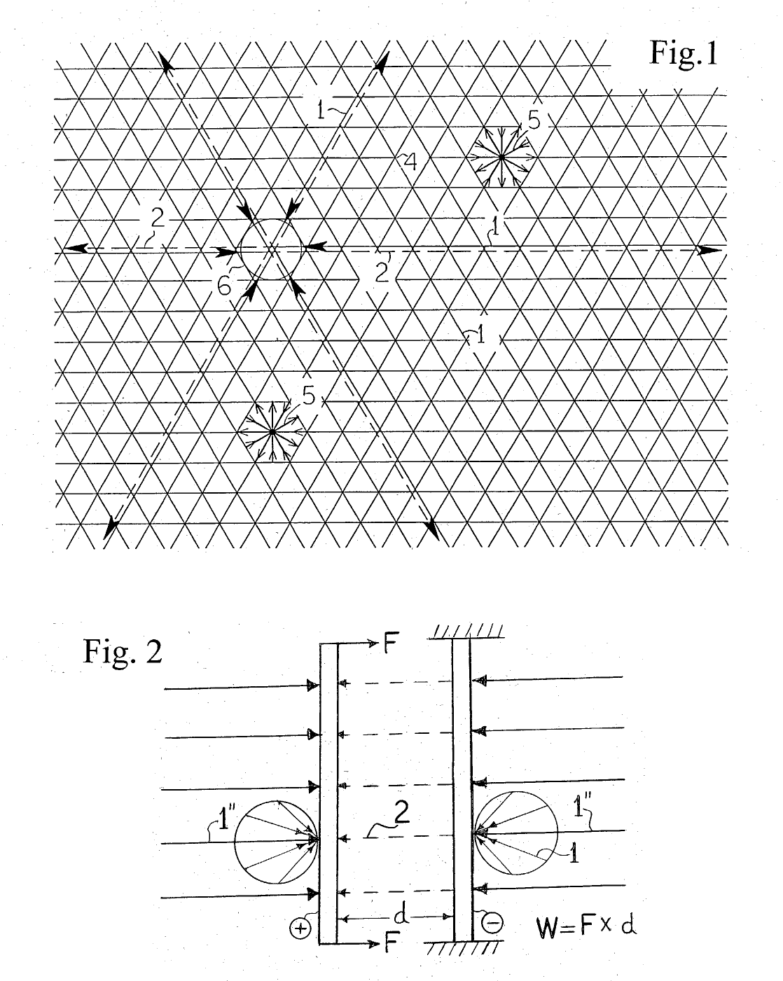

B. Convergent/Divergent nature of this Flux (See FIG. 1).

C. The attenuation of this Flux when traversing electrically charged media.

D. The Cosmic Flux impact force imparted upon the attenuating media.

FIG. 1 is a Schematic diagram of the proposed theoretical Cosmic Flux Track 1 on a 60° Grid. The Particle (or Wave) traverses in both directions on these Tracks un-attenuated in Vacuum. When this Flux traverses a Mass or an Electrostatically Charged Body 6, it suffers Attenuation/Impact, and a Force is imparted upon Body 6 in the direction of Impact. Cosmic Flux 1 exits as Attenuated Cosmic Flux 2. There is no net force on Body 6 (in free space) since it is being impacted from all directions substantially equally. At an intersection of Tracks 1 the Convergent/Divergent 5 nature of the Cosmic Flux is indicated.

It is well known that oppositely charged capacitor plates are forced toward each other a Free Body diagram is shown in FIG. 2. Mechanical energy can be extracted from these plates as they move toward each other for a limited distance “d”. The Cosmic Flux Normal Vector Component 1″ is impinging on the Positive and Negative Capacitor Plates, the Negative Plate is fixed in position. Attenuated Flux 2 is impinging on the Positive plate from the Capacitor inter-space, while stronger un-attenuated Flux 1″ is pushing the Positive Plate toward the Negative Plate. Mechanical Energy hence, can be extracted from the motion of the Positive Plate. Charges ate not being depleted by the energy output of such a System, the Charges are only depleted by Electrical leakages to ground or to opposite polarity elements. The Energy output of the device is supplied entirely by the Cosmic Flux. The scattered Cosmic Flux particles, due to Attenuation/Impact collisions, does not appear to significantly interfere with the virtual “attraction” of the Capacitor Plates. The subject invention attempts to convert the above limited linear motion to a continuous rotary motion (see FIGS. 2, 3, 4, 5, 6, & 7). * * The Force between two charged capacitor plates of 1 meter square area, at 1 centimeter spacing, at 1 Mega-Volts is ˜500 Kgm or ˜1,100 Lbs.

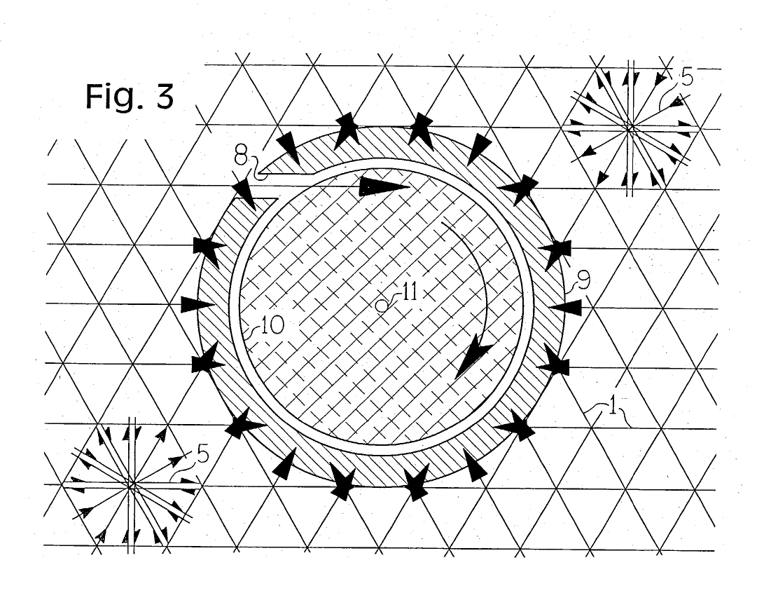

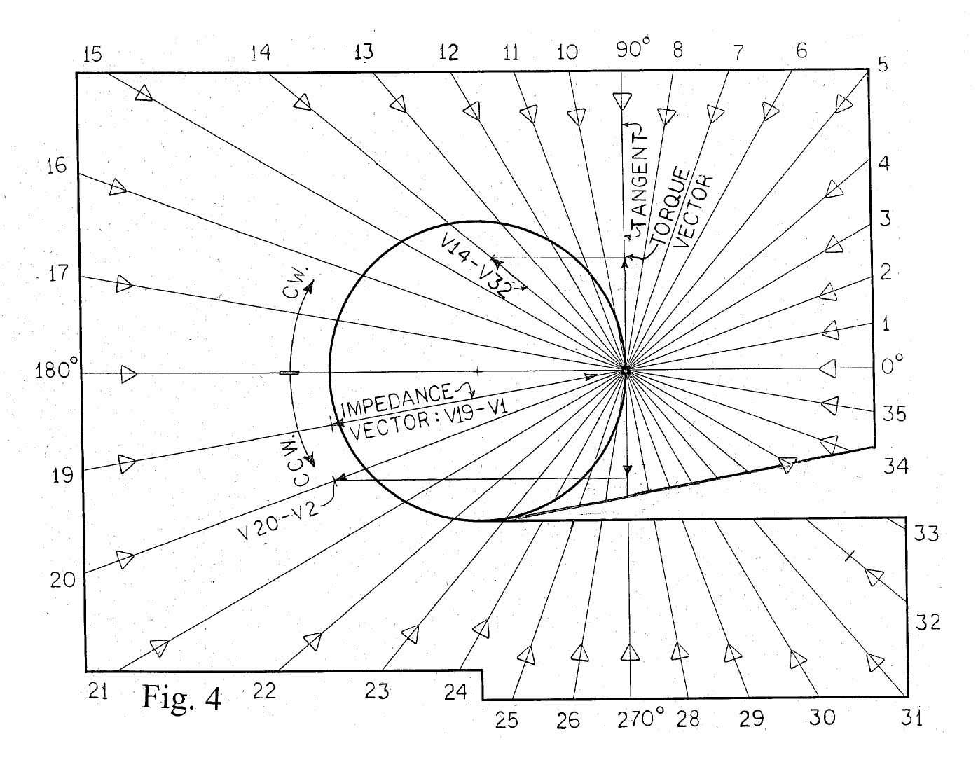

Contemporary conventional Physics implies that since every element in the device is symmetrical about the axis of rotation, no rotary motion can exist due to gravitational or electrostatic “attraction”. This assumption completely disregards the attenuation of specific Cosmic Flux Vectors as they traverse matter in a specific Configuration, with various Flux Impedance Vectors (see FIGS. 4 & 5) The attenuating Cosmic Flux Impact develops the Cosmic Flux Forces in the first place! The terrible fallacy in the “conventional wisdom” is the complete disregard of the phenomena that each differential element in matter can have various Cosmic Flux strength distributions in various directions; it just depends on the surrounding Flux Impedances. It is possible hence to tailor an attenuating Media Stator Configuration that will allow a net Cosmic Flux Force to impinge upon the periphery of an attenuating Media Rotor, and hence drive it (See FIGS. 3, 4 & 5). Assume for the moment that Stator and Rotor in FIG. 3 are made up of an extreme Electrostatically charged Media that is completely impervious to the Cosmic Flux. In this case the Rotor must rotate since the only significant net forces on the Rotor are due to the Cosmic Flux traversing open Slot 8 and impinging upon Rotor 1 periphery region, (the Rotor bearing friction is neglected). Now then if the Rotor and Stator are made of practical “high” Cosmic Flux attenuating composite/charged materials, described in this paper, the Rotor should still develop a torque, alas at a lower energy input/output.

It is imperative that the Charges in the Rotor and Stators are immobilized by electrical insulators (described later in this paper), otherwise the charges would not have a homogeneous distribution in a homogeneous conductor, which is necessary for the CF Turbine operation.

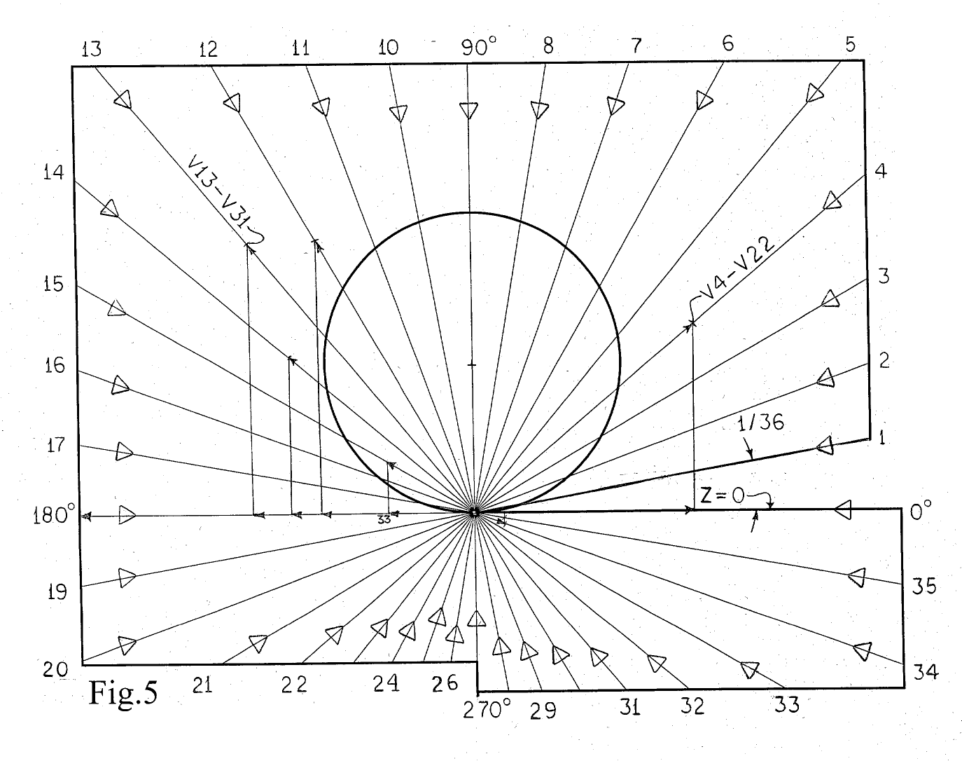

In order to give a comprehensive physical picture of the CF Turbine operation, and to show an approximate calculation that can be used to compare various designs, a Finite Element Graphical Vector Analysis of a representative Electrostatically charged homogeneous matrix Rotor/Stator model is indicated on FIGS. 4 and 5. Points are taken at 45° intervals on the Rotor circumference, from these points radial lines are drawn at 10° intervals covering 360°. Each Line represents a Solid Angle section of the Rotor/Stator traversed by the Cosmic Flux, from the given directions to the Rotor circumference. Flux Attenuation and Impact Force occurs in these Solid Angle sections. The length of the line is proportional to the Cosmic Flux Impedance “Z” of that section: Opposing Vector components (@180°) are resolved, and Vector components tangential to the Rotor circumference are constructed in the clockwise or counter-clockwise directions for each Flux Impedance Line to the Rotor. Of course the value of the Cosmic Flux Impedance Vector is the same in both directions: at 0° and at 180°.

TABLE 1
TABULATED DATA OF COSMIC FLUX IMPEDANCE
VECTOR LENGTHS ON ROTOR CIRCUMFERENCE.
At zero Rotor and Stator Impedance to Cosmic Flux.

| | Forward | Reverse | |
|---|---|---|---|
| Angles | Clock- | Counter- | @ 5% Impedance |
| Degrees | wise (cw.) | clockwise (ccw.) | of R/S |
| 0°& | 4.78 unit | 5.28 unit; FIG. 4. | |
| 360° | | | |
| 45 | 11.54 | 10.61 | Forward Impedance: |
| 90 | 9.45 | 9.85; | 1.05 × {74.9 − |
| | | | 74.9/36} = 76.5* |
| 135 | 9.48 | 12.84 | Reverse Impedance: |
| 180 | 4.50 | 4.62; | 1.05 × 74.9 = 78.6* |
| 225 | 13.48 | 9.28 | |
| 270 | 8.02 | 10.20 FIG. 5. | Driving Torque: |
| | | | 78.6 − 76.5 = ♯2.1C♭ |
| 315 | 13.07 | 12.75 | |
| Total | +74.32 ≈ | −75.43 | ΔImpedance Vectors = 1.11 |

Error is less than 1% of the Total Impedance Vectors of 149.75; Average “Z” = 74.9; Z Vector in Open Slot = 0.
*ROTATION EXISTS.

A 10° Open Slot Solid Angle was used for the Un-attenuated Cosmic Flux Vector input to the Rotor circumference, in a plane perpendicular to the Rotor axis.

TABLE 2
TABULATED DATA OF COSMIC FLUX IMPEDANCE
VECTOR LENGTHS ON ROTOR CIRCUMFERENCE.
At zero Rotor and Stator Impedance to Cosmic Flux.

| | Forward | Reverse | |
|---|---|---|---|
| Angles | Clock- | Counter- | @ 5% Impedance |
| Degrees | wise (cw.) | clockwise (ccw.) | of R/S |
| 0°& 360° | 4.00 unit | 9.95 unit | |
| 45 | 10.42 | 10.20 | Forward Impedance: |
| 90 | 6.94 | 9.61 | 1.05 × {80.19 − |
| | | | 80.19/9} = 74.84* |
| 135 | 8.26 | 13.23 | Reverse Impedance: |
| 180 | 4.40 | 4.40 | 1.05 × 80.19 = 84.20* |
| 225 | 12.41 | 7.06 | |
| 270 | 16.27 | 9.74 | Driving Torque: |
| | | | 84.20 − 74.84 = ♯9.36C♭ |
| 315 | 16.76 | 16.74 | |
| Total | +79.46 ≈ | −80.93 | ΔImpedance Vectors = 1.47 |

Error is less than 1% of the Total Impedance Vectors of 160.39; Average “Z” = 80.19; Z Vector in Open Slot = 0.
*ROTATION EXISTS.

a 20° Open Slot Solid Angle was used for the Un-attenuated Cosmic Flux Vector input to the Rotor circumference, in a plane perpendicular to the Rotor axis; (the Cross Sectional Area of a 20° Solid Angle is 4 times that of a 10° one).

“C” is a Proportionality Constant, it is a function of the Force of the Flux Lines in a Solid Angle per unit length and the Rotor Radius; the number of flux lines in a Solid Angle are constant traversing Vacuum. In a particular CF Turbine one should determine Empirically the Flux Attenuation per unit length, and the Flux gradient per unit length, for the operating Voltage range; this data can be used for further Design purposes.

It is noted that as the number and size of the open Channels are increased, the unimpeded Flux impinging upon the Rotor is increased, while the reverse-Impedance of the Stators are decreased; these Phenomena counteract each other. The above Algorithm can be used to optimize the Power Output per volume of the Turbine.

The Torque on the Rotor can not be calculated from the Constant “k” in the Coulomb Force Equation, since the Charges in the Spheres used in the measurements were distributed totally on the Surfaces. The Force Constant for the particular Charged Array must be obtained Empirically.

The Cosmic Flux traversing totally in the open Slot 8 (Impedance “Z”=0 and impinging upon the Rotor in the cw. direction, is of course Constant and it is not a function of the Rotor and Stator media Impedance. At zero Cosmic Flux impedance (or attenuation) assigned to the Rotor and Stator Media, the sum of all Torque Vector components on the Rotor circumference are of course zero. This serves as a check on the Analysis. The Total Impedance Vectors then can be adjusted by a Media Impedance Factor (1.05 was used in the illustration), to obtain a net Forward Torque and rotation of the Rotor, since the Open Slot Impedance is Constant at Zero.

A relatively small ˜1% A Force Vector value was obtained for the zero Impedance case, in the Finite Element calculations, this error is due to the coarse elements taken, to the construction and measurement errors etc. Increasing the calculated Total Reverse and Forward Impedances by a small amount by assigning an Impedance value, other than zero to the Stator/Rotor media, that is multiplying the Rotational Impedance Vectors by a factor over 1.0, a Cosmic Flux induced Net Torque will exist on the Rotor in the cw. direction. With a Cosmic Flux 100% attenuated traversing in the Stator, the Torque on the Rotor is maximum; and an Electrostatic Black Hole has been created, except for the Flux in the Slots. At this Cosmic Flux Impedance level the Rotor Torque is Constant as the Media Impedance level is further increased; the penetrating power of the Cosmic Flux is not infinite (Black Holes).

It is possible that an Electrostatic Black Hole is also a Gravitational Black Hole, if there is only one type of Cosmic Flux Particle, reacting with various Media (Mass, Electric Charge, Magnetic Dipoles). Also another condition that has to be met for efficiency comparisons: the Flux traversed in each of the tangential Slot regions reaching past the axis of rotation, developing some reversed Torque, must be equal for the comparisons of related Turbine Designs.

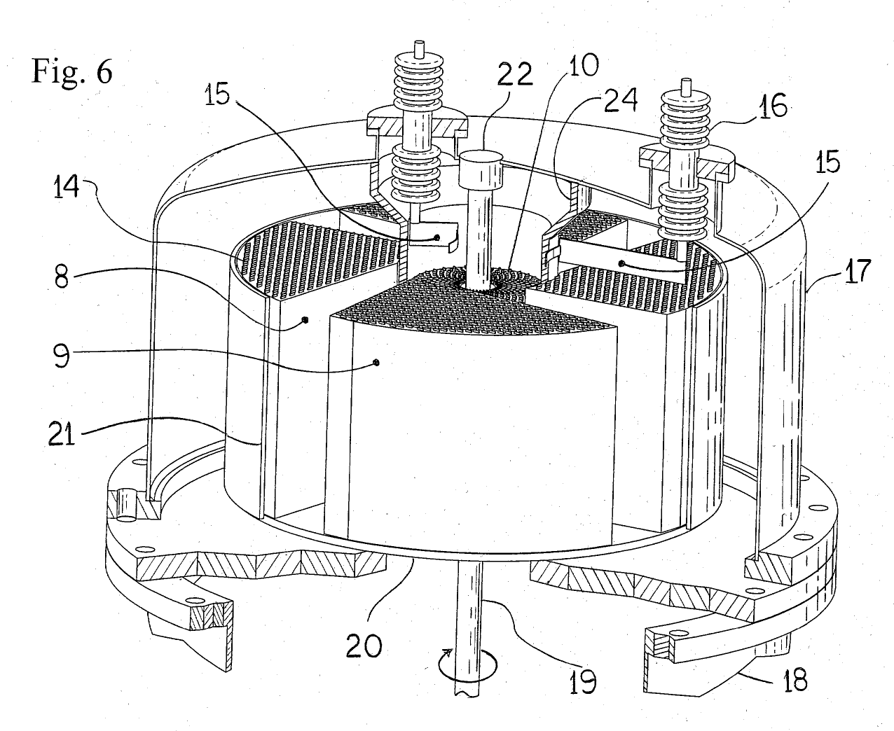

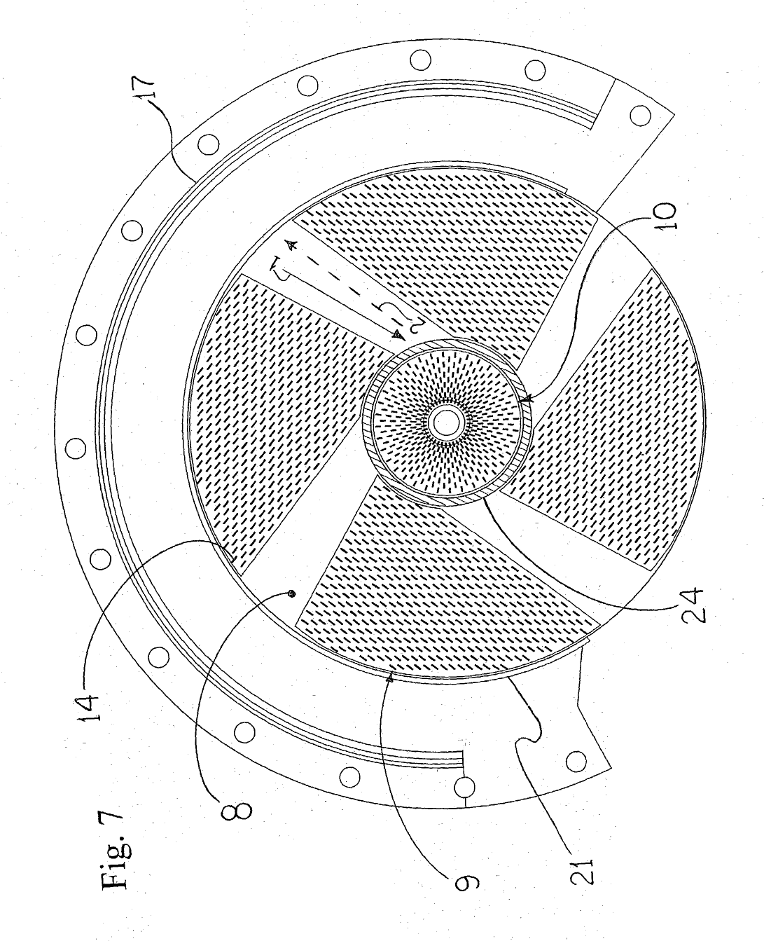

The Cosmic Flux Turbine in FIG. 6 & FIG. 7 shows the proposed configuration. This device comprises of Rotor 10 surrounded by four Stators 9. Both the Rotor 10 and the Stators 9 are made up of a multitude of electrical conductor Strips 14 which are substantially parallel with the Rotor Shaft 19, with one end of said Strips 14 are exposed so that they can be individually charged by scanning Linear Electron Beam Guns 15 in a Vacuum Chamber 17. The inside surfaces of this chamber is coated with a dielectric material in order to minimize current leakage to ground. A Dielectric Cylinder 21 is bonded to Stators 9 for mechanical stability and for added electrical insulation. A Dielectric Shield 24 is placed between Rotor 10 and Stators 9 in FIG. 6 for arc suppression purposes. Conventional Brushes of Graphite may also be used to contact and charge Strips 14; in this case Chamber 17 may be pressurized with an arc suppressor gas.

Serration and Quasi-metalization should be used (not shown) on Shield 24, in order to minimize wall charging, hence surface flash-overs, and punctures. Scanning by the “Stator's Linear “E” Gun is accomplished by rotation of Stators 9 on Rotor Shaft 19.

The electrically insulated conductor Strips 14 are utilized to confine the charges in the desired locations in the applied Electric Field. Said Stators 9 are arranged in such configuration that they attenuate Cosmic Flux impinging upon Rotor 10 (FIG. 7) in the counterclockwise direction. Four open Channels 8 are provided for the Flux to impinge upon Rotor 10 periphery un-attenuated in the clockwise direction, hence develop a net clockwise torque and cause rotation of Rotor 10.

A multitude of Rows of these Strips 14 are arranged so that they further increase the impedance to the Cosmic Flux traversing them and impinging upon the periphery region of Rotor 10 in the counterclockwise (or reverse) direction.

The fabrication in mass production of Rotors 10 and Stators 9 are relatively simple and inexpensive. Plates of Thermoplastics are vapor deposited on one side through “line masks” to form Strips 14. Said metallized Plates are then bonded together to form Stators 9. Wedges of Thermoplastics can also be metallized similarly, and bonded together to form Rotors 10. A multiplicity of Strips 14 on a tape can also be rolled up like a cylindrical capacitor. Metals such as Aluminum, Copper, or Nickel, are suitable for these purposes to form an array of Strips 14.

Some Thermoplastics have dielectric strengths of over 1,000 Volts per mil, so that a 1 inch thick insulation on the surface of Stators 9 and Rotors 10 should withhold a Voltage differential of at least 1 Mega-Volts. In an array of charged Strips 14 operating at 1 Mega-Volts each, substantially no voltage differential should exist between adjacent Strips 14. Voltage will, of course, exist between Strips 14 to the grounded Vacuum Chamber 17. An array of 100 layers of Strips 14 should attenuate the Cosmic Flux traversing them, equivalent to an Impedance of ˜100 Mega-Volts!

Generator Chamber 18 is attached to Turbine Chamber 17. These Chambers may be open to each other, so that no generally unreliable rotating seal is required between them. These Chambers 17 and 18 may also be separated by a non magnetic wall, and a magnetic shaft coupling is utilized to transfer mechanical power from Chamber 17 to Chamber 18. In this case the Turbine can run in Vacuum, or in an Inert, or Electro-negative gas; while the Generator Chamber can be pressurized for heat conduction/convection purposes. A Speed Reducer may be utilized in the Generator Chamber 18 in order to be able to run the Turbine as fast as practical for increased power output, while generating a 60 cps. AC current.

A Dielectric Cylinder 21 surrounds the Stators 9 for Arc suppression and for increased mechanical strength purposes. Rotor Shaft 19 is supported by Bearing 22 attached to Chamber 17, while the other end of Shaft 19 is supported by a Bearing in the Generator Chamber 18, or at the interface between Chambers 17 and 18.

Nev-Brainard-Nev Cosmic Flux Field Theory

FIRST. A Cosmic Flux Field is produced by a relatively uniform flux emanating from the so far undetectable Cosmos, producing a simultaneously convergent-divergent Flux Field at every point in the Cosmos, except in the vicinity of Black Holes, where the Cosmic Flux flows only toward it.

SECOND. The Cosmic Flux is attenuated by masses, charges, and magnetic poles; the magnitude of the attenuation is directly proportional to the magnitude of the mass, charge, and magnetic pole strength, respectively, and the length of the traverse.

THIRD. Every mass, charge, and magnetic pole is at the focus of its Attenuated Cosmic Flux Field, except a Black Hole Mass which absorbs all Cosmic Flux impinging upon it. The Flux Field Strength in Vacuum is inversely proportional to the square of the distance from the effective focal-point.

FOURTH. A net force is produced on a mass, charge, and magnetic pole, if the uniform Cosmic Flux impinging upon it is unbalanced by some Attenuated Flux. The force is in the direction along the Attenuated Flux.

FIFTH. The Attenuation/Momentum Transfer in an Impeding Media is not perfectly Elastic, some heat is generated in this Process; which is hitherto undetectable on relatively “small” Masses. (In Black Hole core matter the total Flux Energy must be trapped; significant Cosmic Flux heating effect is expected in Stars and Planets).

SIXTH. In a solid angle the number of Flux Lines traversing toward the Apex is constant in a non impeding media. In an Impeding Media the Flux Lines diminish in the direction of motion, as collisions with matter deflect some of the Cosmic Particles.

SEVENTH. The Flux Particle paths are normally straight lines in vacuum, traversing matter they are scattered due to collisions; the number of these collisions are directly proportional to the path length and the Cosmic Flux Impedance (density) of the Media. In the known Elements the collisions are relatively rare. Significant Forces can be produced due to the “high” Energy and high Flux density per unit volume/sec. of the Cosmic Flux.

EIGHT. Nuclear disintegration releases the Cosmic Flux. Most of the Cosmic Flux is generated by myriads of “older than our” Big Bangs, in the so far undetectable Cosmos. Supernovae and Colliding Galaxies also produce Cosmic Flux. most of this Flux is absorbed by Black Holes. This is more or less a closed System of Flux Energy. The “Big Bangs” and the Black Holes have been going on simultaneously at myriads of locations in the hitherto Undetectable Cosmos, for Eons.

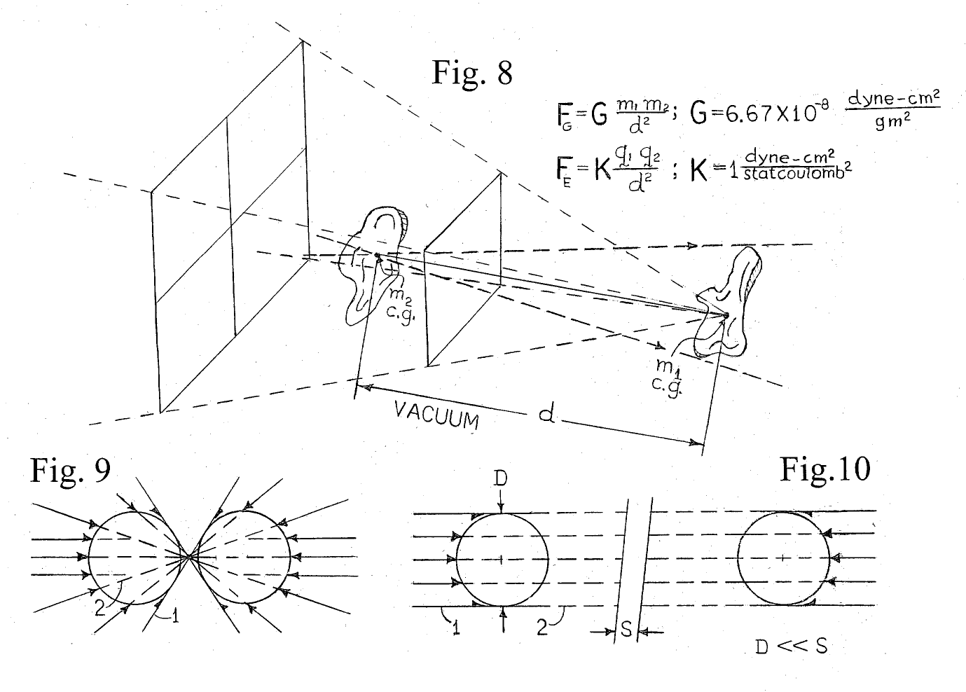

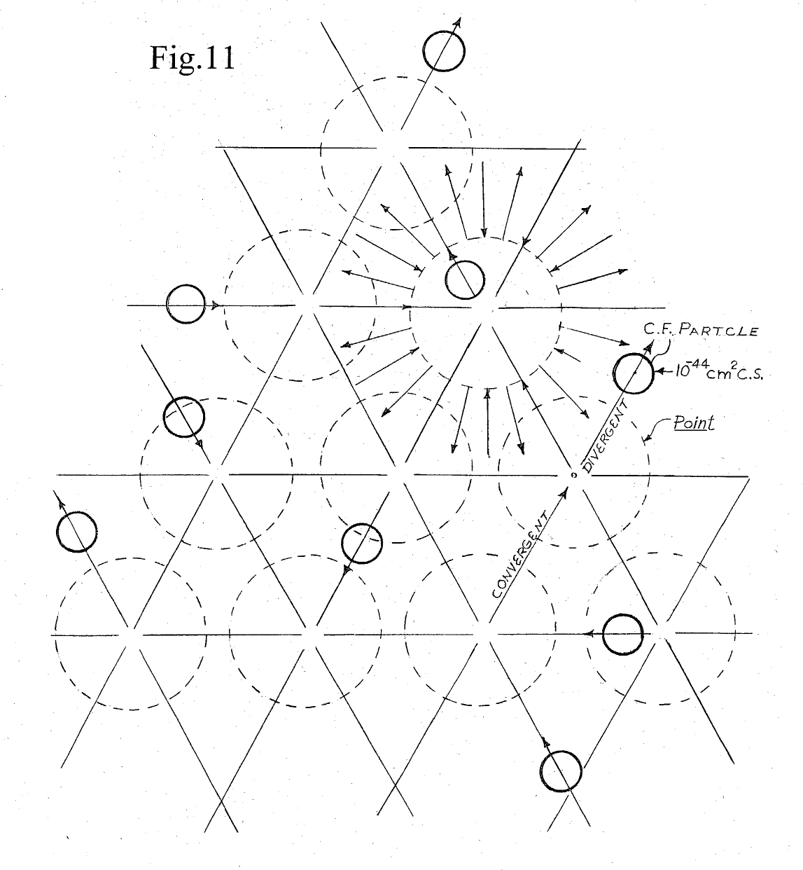

The Ney-Brainard-Ney (NBN) Theory indicates that the “attenuation of the Cosmic Flux traversing matter” is a more fundamental principle to determine Gravitational/Electrostatic Forces than Newton's form of Equation of Gravitational Force. The Newton/Coulomb type Equation, as written, precludes any Gravitational/Electrostatic Torque on a Rotor. Newton's Equation of Gravitational Force (FIG. 8), with Lumped Point Flux Impedances at Centroids and artifact Impedance spacings “d”, is a greatly simplified specific version of the “Cosmic Flux Attenuation Traversing Matter Caused Impact Force Principle” of the NBN Cosmic Flux Theory.

The NBN Theory is applicable in all cases of Gravitational and Electrostatic Force calculations, it gives a much better insight to these Cosmic Flux Generated Forces surrounding us.

Newton probably had a somewhat similar Model for “Mass Attraction”, to that espoused by Descartes, but did not dare to publish the Model (after Galileo's problems a few decades prior), lest he has to repudiate his theory or get his head lopped off in the Tower of London for heresy. Invisible particles (unheard of at the time) traversing the Earth and also “raining” down on us, is clearly blaspheme against God, Christianity, and the Holy Bible. Newton's Equation format published in the “Principia” did not bother the Church. No doubt they did not understand its hidden implications, few other people do even at our time.

Newton's Equations are highly accurate for Astronomical applications, where the Mass Spacings are orders of magnitude larger than the Spherical Mass Diameters, and they are immersed in a non impeding Media (Vacuum). For complex configurations at close proximity the Newton/Coulomb Equations are not applicable. The Cosmic Flux Impedance Parameter of the Media is inserted into the Equation as the “Mass/Charge at a center of gravity/centroid”. This works well for Spherical configurations at large Spacing/Diameter ratios. Also the Newton/Coulomb Force Equations assume a non Impeding Media between the Masses/Charges, it does not apply to domains within an Impeding Media.

The Newton/Coulomb Equations do not account for the Attenuation of the Cosmic Flux Lines traversing the Media in any specific path. Conversely the NBN Cosmic Flux Force Algorithm applies to all domains.

It is interesting to note that the subject CFT is the only Turbine where the Rotor speed is not limited by the driving “jet” speed, since the “jet” is moving with at least the speed of light. The Rotor Torque Input is substantially constant at any operating speed. It follows that the Power output is directly proportional to the Rotor speed. (frictions are neglected). It is hence is desirable to operate this Turbine at a “high” practical speed and use a Speed Reducing Device to the Electric Generator to obtain the desired Frequency output for AC or desired Voltage output for DC.

Generator Power output regulation may be obtained by increasing or reducing the Charges in the Rotor/Stator by an electronic control system.

The Cosmic Flux Energy is available everywhere in our Galaxy at all times, at a “tremendously high” and steady Power level. Other advantages are: zero Fuel Cost, zero Pollution, and a relatively inexpensive Device (in mass production) to harness it. Moreover with small local Cosmic Flux Turbo-Electric Generators, there should be no power and fuel distribution cost to household and industrial users etc. . . Also, power grid distribution failures due to storms, terrorist acts, Earth-quakes, equipment failures, forest fires, or other calamities should be non existent.

Eventually when reliable ultra-high speed Bearings, high strength Rotors, and electric/mechanical high speed-reduction Transmissions are developed, these Turbines may be developed for automotive, marine, and aircraft propulsions. No refueling is ever needed, also there is no fuel load to carry.

Crude oil is in highly limited supply in the World: Crude oil products must not be burned in Engines! In the long run it will only be use for producing Lubricants, Plastics, Paints, etc. . .

It should be appreciated by those skilled in the art, that this invention may take various forms of embodiments other than those heretofore described. Accordingly we intend by the following claims to cover all modifications within the spirit and scope of our invention.

What we claim are new and pray to secure by Letters Patent of the united states are:

1. An Electro-statically charged Rotor surrounded by one or more Electro-statically charged Stator/s said Stator/s contain one or more open Slots directed substantially tangent toward the periphery region of said Rotor in order to allow the Cosmic Flux to impact said Rotor unimpeded at the periphery region in one direction of rotation while said Stator/s are impeding some of said Cosmic Flux to impact said Rotor in the reverse direction of rotation and hence develop a net forward torque and cause rotation of said Rotor on an integral Rotor Shaft mounted on low friction bearings.

2. The invention as described in claim 1, wherein the Rotor Shaft is connected to the shaft of an Electric Generator in order to drive said Electric Generator and generate Electric Power.

3. The invention as described in claim 1, wherein said Stator/s, and Rotor mounted on a Shaft henceforth to be called Cosmic Flux Turbine herein said Stator/s and Rotor are made up of a Dielectric material with an array of individually insulated electrical Conductors imbedded in said Dielectric material for the purpose of maintaining the position of the charges which would otherwise change positions in an impressed Electric Field.

4. The invention as described in claim 3, wherein said individually insulated electrical conductors imbedded individually in said Dielectric material said electrical Conductors are slender elongated members aligned substantially parallel with the Shaft of said Rotor and said slender elongated members are exposed at one end so that they can be Electro-statically charged from an external Source.

5. The invention as described in claim 1, wherein the Rotor and Stator Assembly is enclosed in a hermetically sealed Chamber with the Chamber walls coated with a Dielectric material in order to minimize Electric charge leakage to Ground said Chamber containing a wall of Dielectric material hermetically sealed between said Rotor and said Stator/s to form separate Rotor and Stator Chambers in order to minimize electric arc-overs between said Rotor and Stator/s.

6. The invention as described in claim 5, wherein said hermetically sealed individual Rotor and Stator Chambers are evacuated and Linear Electron Guns are operated in proximity of the exposed ends of said conductors in the Rotor and the Stator/s for the purpose of Electro-statically charging said conductors and scanning of the Stator/s is accomplished by a rotation of said Stator/s about the Rotor Axis.

7. The invention as described in claim 5, wherein said hermetically sealed Chambers are pressurized with an inert gas or an Electro-negative gas for the purposes of arc suppression and mechanical brush type contactors are wiping said exposed ends of said conductors in the Rotor and Stator/s for the purpose of Electro-statically charging said conductors wherein the scanning of the Stator/s is accomplished by a rotation of said Stator/s about the Rotor Shaft.

8. The invention as described in claim 5, wherein the hermetically sealed Turbine Chamber contains hermetically sealed high voltage Electrical feed-throughs in order to opposite polarity elements the power output of said Cosmic Flux Turbine of course does not use up any of the charge in the Cosmic Flux Turbine System Power output.

9. The invention as described in claim 5, wherein the hermetically sealed Turbine Chamber is connected to another hermetically sealed Chamber containing an Electric Generator with hermetically sealed Electric output terminals passing through the Chamber walls wherein the Cosmic Flux Turbine Rotor shaft is connected to the Electric Generator shaft either directly or through a Speed Reducing Gear Train in a common atmosphere with said Rotor chamber so that no generally unreliable rotating seal is required between Turbine Rotor shaft and Electric Generator drive shaft.

10. The invention as described in claim 9, wherein the Turbine Chamber and the Generator Chamber are separated by a wall of non magnetic material and the rotary motion of the Turbine is transferred to the Generator by a Magnetic Coupling so that the Turbine Chamber can be evacuated for the Electron Gun operation. while the generator Chamber can be pressurized by a gas for cooling purposes.

11. The invention as described in claim 10 wherein the Turbine Rotor Shaft is connected to the Generator Shaft through a Speed Reducer Device in order increase Turbine Power Constant at any practical speed and still obtain the desired Alternating Current frequency output.

12. The invention as described in claim 10 wherein the Turbine Rotor Shaft is connected to the Generator Shaft through a Speed Reducer Device in order increase Turbine Power Output at increased Rotor speed since the Rotor Torque is substantially Constant at any practical speed and still obtain the desired Direct Current Voltage output.
